(19) United States
(12) Patent Application Publication
(10) Pub. No.: US 2011/0017933 A1
(43) Pub. Date: Jan. 27, 2011

(54) Spout control valve for water drinking machines

(76) Inventor: Ching-Yu Kuo, Ho Mei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/458,742

(22) Filed: Jul. 22, 2009

(51) Int. Cl. F16K 1/32; E03B 9/20

(52) U.S. Cl. 251/321; 239/24

(57) ABSTRACT

A spout control valve for water drinking machines aims to be assembled and installed easily and provide smooth water supply. The control valve is located in a spout of a water drinking machine. The control valve has an integrated valve seat made of non-lead material. An action seat and a drawing seat are provided to move together. The drawing seat has a stopper plug to butt an outlet of a first water passage of the valve seat to control opening and closing of water supply.

### BACKGROUND OF THE INVENTION

1. Field of the Invention

The present invention relates to a spout control valve for water drinking machines and particularly to a spout control valve of a water drinking machine that can be assembled and installed easily and provide smooth water supply.

2. Description of the Prior Art

The conventional spout control valve of a water drinking machine (referring to FIG. 1) mainly has a control valve 2 located in a spout 1 of the water drinking machine. The spout 1 also has, in this order, an inner holding seat 11, a pushbutton 12 and an outer holding seat 13 to retain the control valve 2. Through opening and closing of the control valve 2 the spout 1 can supply water. Such a structure still has drawbacks in practice, notably:

1. The elements forming the conventional control valve 2 mostly are made of lead. As lead is harmful to human health, it is forbidden in advanced countries.

2. The conventional control valve 2 has a valve cap 21 and a valve body 22 formed by metal stamping. Such a process usually forms acute edges at their junctures and result in scraping and damaging of the edge 231 of the stopper plug 23 that would cause water leakage.

3. The valve body 22 of conventional control valve 2 has a water passage 24 formed by connecting multiple ducts 241 and 242. Connecting defects easily happen. The cost also is higher. Product competitiveness suffers.

### SUMMARY OF THE INVENTION

Therefore the present invention aims to provide a spout control valve for water drinking machines that can be assembled and installed easily and provide smooth water supply. According to the invention a control valve is provided in a spout of a water drinking machine. The control valve has a valve seat formed integrally from a non-lead material. The invention further provides an action seat to hook a drawing seat that move together. The drawing seat has a stopper plug butting an outlet of a first water passage of the valve seat to control opening and closing of water supply. Such a structure can facilitate assembly and installation, and also maintain smooth water supply.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a sectional view of a conventional spout control valve of a water drinking machine.

FIG. 2 is an exploded view of an embodiment of the invention.

FIG. 3 is an exploded view of the control valve of the invention.

FIG. 4 is a sectional view of the valve seat of the invention

FIG. 5 is a schematic view of the action seat and drawing seat of the invention in a coupled condition.

FIG. 6 is a sectional view of the invention in operating condition-1.

FIG. 7 is a sectional view of the invention in operating condition-2.

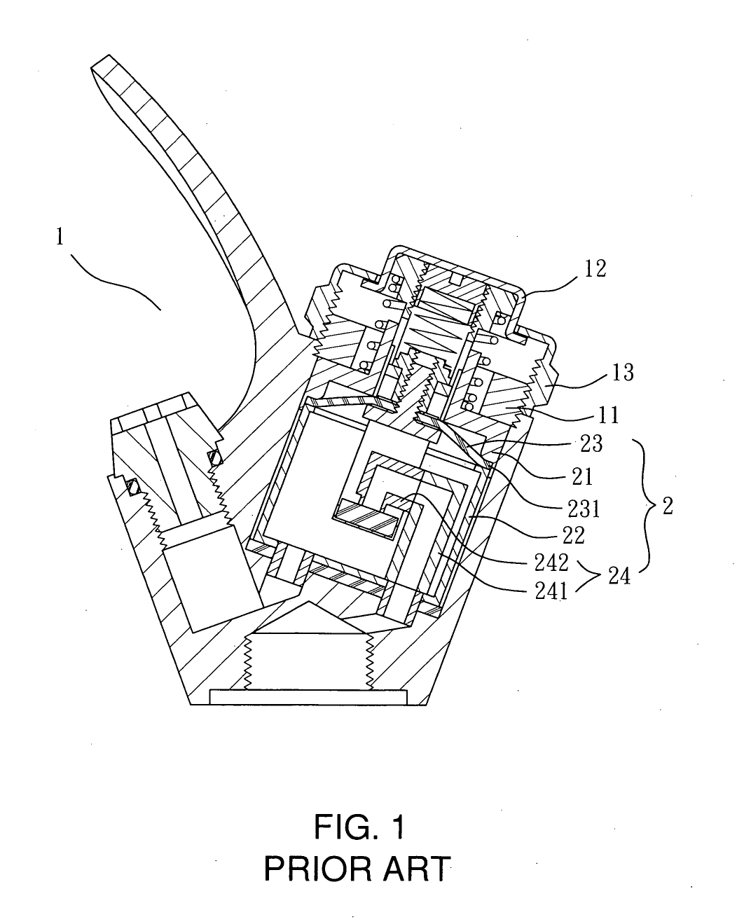

### DESCRIPTION OF THE PREFERRED EMBODIMENTS

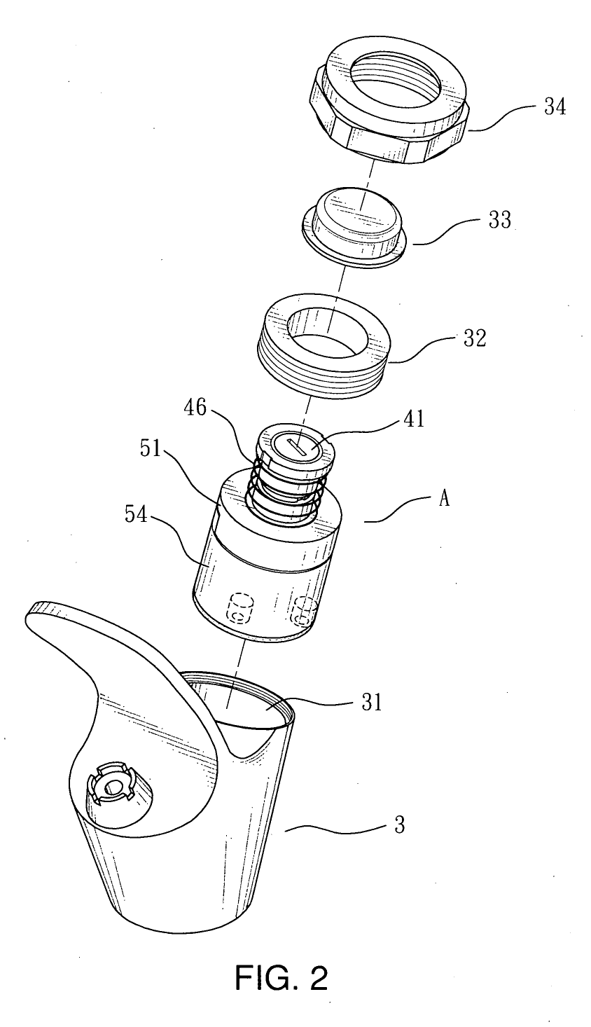

Please referring to FIGS. 2 through 7, the spout control valve of water drinking machines according to the invention mainly has a water control chamber 31 in a spout 3 of a water drinking machine to house a control valve A, and also house in this order, an inner holding seat 32, a pushbutton 33 and an outer holding seat 34 to retain the control valve A. The control valve A includes an upper valve assembly 4 and a lower valve assembly 5.

The water control chamber 31 has the bottom communicating with a water intake passage 36 and a water discharge passage 35. The water discharge passage 35 is connected to a water channeling seat 37 to discharge water through a water discharge duct 371.

The upper valve assembly 4 is a standard element consisting of a first adjustment element 41, a first elastic element 42, a second adjustment element 43, a sleeve 44 and a second elastic element 46.

The first adjustment element 41 has a first screw thread 411 on the periphery and an adjustment slot 412 at the top and a retaining strut 413 extended from the center of the bottom thereof.

The first elastic element 42 has one end pressed and retained by the first adjustment element 41.

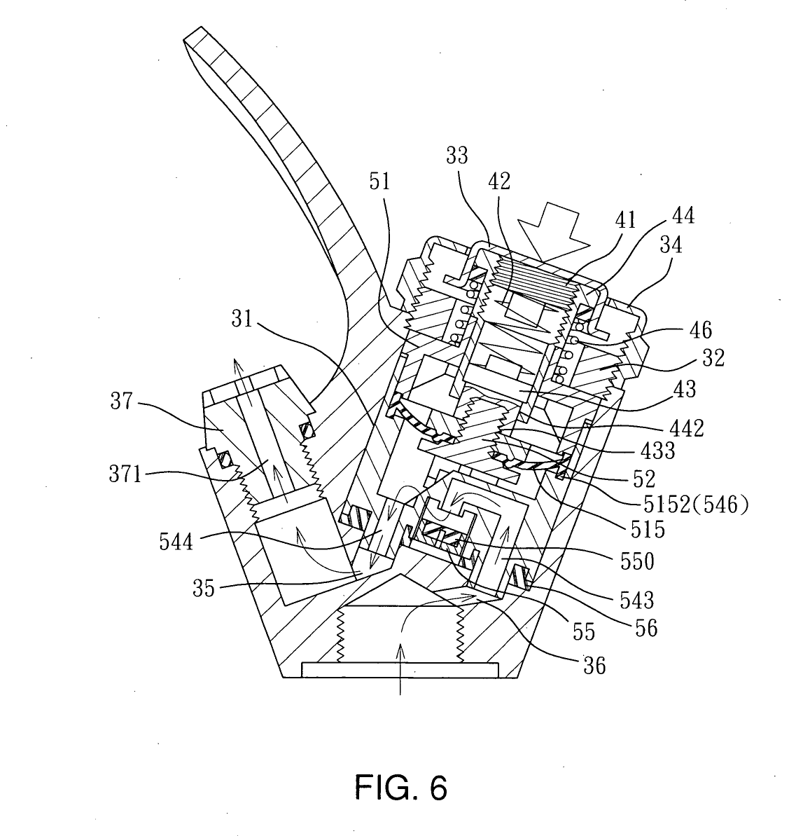

The second adjustment element 43 has an anchor strut 431 at the top with a retaining notch 432 formed thereon to hold another end of the first elastic element 42, and an internal screw hole 433 formed at the bottom thereof (referring to FIG. 6).

The sleeve 44 has a housing room 441 which has a second screw thread 4411 formed on the periphery and also holds the first and second adjustment elements 41 and 42, and the first elastic element 42. The first and second screw threads 411 and 4411 are fastenable to engage the first adjustment element 41 and the sleeve 44. The sleeve 44 has an aperture 442 at the bottom, and forms a multi-step periphery that includes a first retaining step 444 and a second retaining step 445.

The second elastic element 46 is coupled on the periphery of the sleeve 44 with one end pushing the first retaining step 444 of the sleeve 44.

The lower valve assembly 5 includes a valve cap 51, a third adjustment element 514, an upper pad 515, an action seat 52, a valve seat 54, a drawing seat 55 and a lower pad 56.

The valve cap 51 has a jutting ring 512 at the top with an opening 511 formed thereon, and at least one retaining notch 513 formed on the periphery.

The third adjustment element 514 has a screw hole 5141 in the center.

The upper pad 515 has a hole 5151 and a retaining flange 5152 extended downwards from the circumference.

The lower pad 56 has at least one coupling hole 561.

The invention provides more features as follow:

The action seat 52 has an upper coupling section 521 at the upper side that has a thread section 5211 formed thereon. The upper coupling section 521 runs through the hole 5151 of the upper pad 515 and fastens to the third adjustment element 514 and second adjustment element 43 by screwing through the tread section 5211 with the screw hole 5141 and the internal screw hole 433. The action seat 52 further has a lower coupling section 522 extended from the bottom thereof and formed substantially in a [symbol] -shape with two sides each has an inner wall formed a retaining rib 523 and a first hook 524.

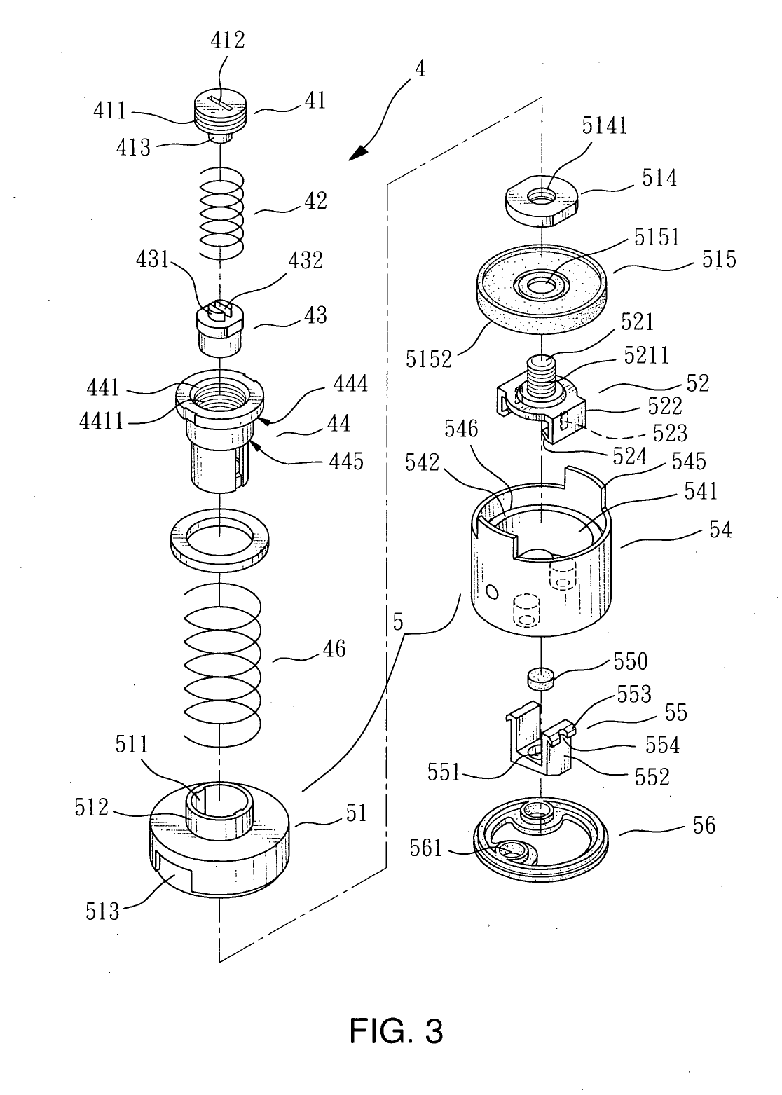

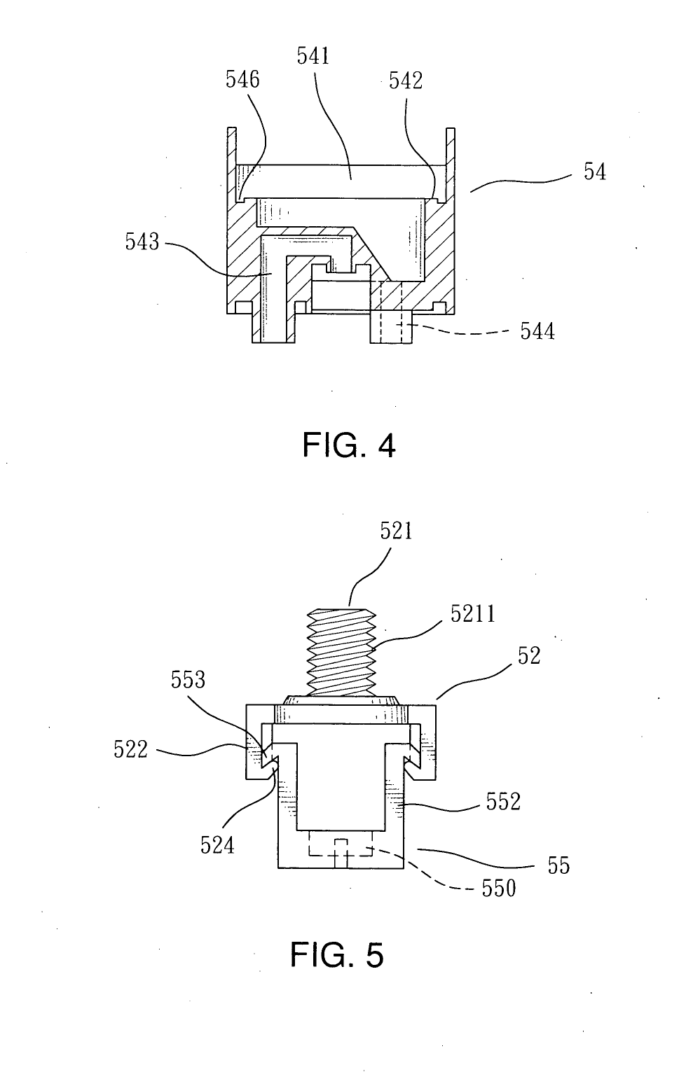

The valve seat 54 (also referring to FIGS. 3 and 4) is formed in an integrated manner, and has a housing space 541 inside and a retaining deck 542 formed on the periphery of the housing space 541 to hold the upper pad 515 and the valve cap 51. The retaining deck 542 has a retaining trough 546 to retain the upper pad 515 and allow it to fully cover the upper portion of the housing space 541.The valve seat 54 has a first water passage 543 and a second water passage 544. The first water passage 543 communicates with the water intake passage 36. The second water passage 544 communicates with the water discharge passage 35. The valve seat 54 further has at least one retaining plate 545 on the periphery corresponding to the retaining notch 513 of the valve cap 51.

The drawing seat 55 has a holding trough 551 to hold a stopper plug 550, and a coupling portion 552 extended upwards from each of two sides thereof. The coupling portion 552 has a distal end formed a second hook 553 latchable with the first hook 524 of the action seat 52 (referring to FIG. 5). The second hook 553 has a notch 554 corresponding to the retaining rib 523 of the first hook 524 for wedging so that the drawing seat 55 and the action seat 52 are moved together to allow the stopper plug 550 to butt the outlet of the first water passage 543 to control opening and closing of water supply.

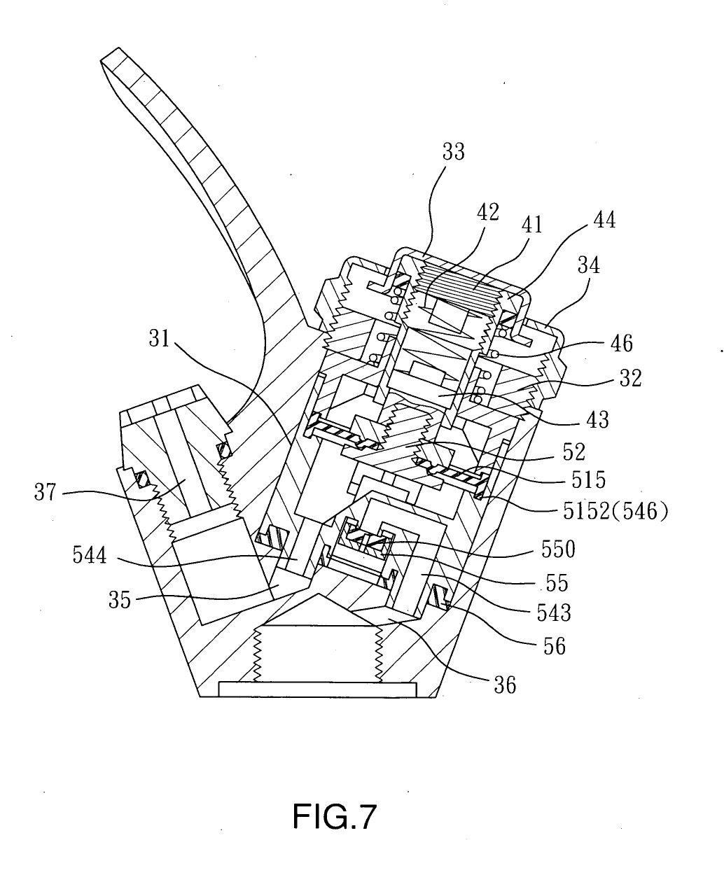

By means of the construction set forth above, when in use to supply drinking water through the spout 3, push the pushbutton 33 (referring to FIGS. 4 and 6), the control valve A is compressed to move the sleeve 44, the first and second elastic elements 42 and 46, action seat 52 and drawing seat 55 downwards; the drawing seat 55 is lowered without butting the outlet of the first water passage 543, thus the drinking water can flow through the first water passage 543 and the housing space 541 of the valve seat 54 into the water discharge passage 35 of the second water passage 544, and be ejected through the water discharge duct 371. Water can be supplied smoothly for user drinking. To stop water supply, release the pushbutton 33, the second elastic element 46 which has a greater elastic force than the first elastic element 42 pushes the pushbutton 33, sleeve 44, action seat 52 and drawing seat 55 upwards so that the stopper plug 550 butts the outlet of the first water passage 543 again to stop water supply (referring to FIGS. 4 and 7).

I claim:

1. A spout control valve for water drinking machines comprising an upper valve assembly and a lower valve assembly that are housed in a water control chamber of a spout of a water drinking machine, the water control chamber also holding an inner holding seat, a pushbutton and an outer holding seat in this order to retain the control valve, wherein:
the upper valve assembly includes a first adjustment element, a first elastic element, a second adjustment element, a sleeve and a second elastic element; the first adjustment element having a first screw thread on the periphery and an adjustment slot at the top and a retaining strut extended from the center of the bottom thereof; the first elastic element having one end pressed and retained by the first adjustment element; the second adjustment element having an anchor strut at the top and an internal screw hole formed at the bottom thereof; the sleeve having a housing room which has a second screw thread formed on the periphery engageable with the first screw thread of the first adjustment element; and the second elastic element being coupled on the periphery of the sleeve; and
the lower valve assembly includes a valve cap, a third adjustment element, an upper pad, an action seat, a valve seat, a drawing seat and a lower pad; the valve cap having a jutting ring at the top with an opening former thereon; the third adjustment element having a screw hole in the center; the upper pad having a hole and a retaining flange extended downwards from the circumference thereof; and the lower pad having at least one coupling hole;
wherein:
the action seat has an upper coupling section at an upper side running through the upper pad and a lower coupling section extended from the bottom thereof;
the valve seat is formed in an integrated manner and has a housing space inside and a retaining deck formed on the periphery of the housing space to hold the upper pad and the valve cap, and a first water passage and a second water passage; and
the drawing seat has a holding trough to hold a stopper plug and a coupling portion extended upwards to couple with the lower coupling section of the action seat.

2. The spout control valve for water drinking machines of claim 1, wherein the valve cap has at least one retaining notch on the periphery thereof.

3. The spout control valve for water drinking machines of claim 1, wherein the lower coupling section of the action seat has two sides each having an inner wall with a retaining rib formed thereon

4. The spout control valve for water drinking machines of claim 1, wherein the lower coupling section of the action seat has two sides each having a first hook formed thereon.

5. The spout control valve for water drinking machines of claim 1, wherein the valve seat has at least one retaining plate on the periphery thereof.

6. The spout control valve for water drinking machines of claim 1, wherein the coupling portion of the drawing seat has two sides each having a distal end formed a second hook with a notch formed thereon.
